(19) United States
(12) Patent Application Publication
(10) Pub. No.: US 2015/0346366 A1
(43) Pub. Date: Dec. 3, 2015

(54) SEISMIC ACQUISITION SYSTEM COMPRISING AT LEAST ONE CONNECTING MODULE TO WHICH IS CONNECTED AN AUXILIARY EQUIPMENT, CORRESPONDING CONNECTING MODULE AND DATA MANAGEMENT SYSTEM

(71) Applicant: SERCEL, Carquefou (FR)

(72) Inventors: Gaetan Mellier, Houston, TX (US); Simon Leboeuf, Monnieres (FR); Alexis Duboue, Carquefou (FR); Noel Voisin, Lorient (FR)

(21) Appl. No.: 14/512,038

(22) Filed: Oct. 10, 2014

Related U.S. Application Data
(60) Provisional application No. 62/003,931, filed on May 28, 2014.

(51) Int. Cl. G01V 1/22

(52) U.S. Cl. CPC G01V 1/22; G01V 1/38

(57) ABSTRACT

A seismic data acquisition system includes at least one marine seismic streamer towed by a vessel. The at least one seismic streamer includes a seismic telemetry cable, extending along the at least one seismic streamer and adapted to communicate seismic data with the vessel, and connecting modules to which is connected an auxiliary equipment. Each connecting module is connected to the seismic telemetry cable, enabling the auxiliary equipment to communicate auxiliary data with the vessel, via the connecting module and the seismic telemetry cable.

### 1. CROSS-REFERENCE TO RELATED APPLICATION

The present application is based on and claims the benefit of U.S. provisional patent application Ser. No. 62/003,931, filed May 28, 2014, the content of which is hereby incorporated by reference in its entirety.

### 2. FIELD OF THE DISCLOSURE

The field of the disclosure is that of equipments for the seismic prospection.

More specifically, the disclosure relates to a seismic data acquisition system comprising marine seismic streamers towed by a vessel.

The disclosure can be applied notably to the oil prospecting industry using seismic method (sea oil survey), but can be of interest for any other field which requires a system performing geophysics data acquisition in a marine environment.

### 3. TECHNOLOGICAL BACKGROUND

It is sought more particularly here below in this document to describe problems existing in the field of seismic data acquisition for oil prospecting industry. The disclosure of course is not limited to this particular field of application but is of interest for any technique that has to cope with closely related or similar issues and problems.

In marine seismic exploration, the operations of acquiring seismic data on site conventionally use networks of sensors distributed along cables in order to form linear acoustic antennas, also referred to as “streamers” or “seismic streamers”. The seismic streamers are towed through water behind a vessel at a water depth that can be more or less deep.

A marine seismic method is usually based on analysis of reflected seismic waves. Thus, to collect geophysical data in a marine environment, one or more submerged seismic sources are activated in order to propagate seismic wave trains. The pressure wave generated by the seismic source passes through the column of water and insonifies the different layers of the sea bed. Part of the seismic waves (i.e. acoustic signals) reflected are then detected by the seismic sensors distributed over the length of the seismic streamers. These acoustic signals are processed and transmitted through the telemetry from the seismic streamers to a central unit onboard the vessel, where they are stored and processed.

As shown in FIG. 1, a network of seismic steamers 10a to 10e is towed by a seismic vessel 11. A seismic streamer 10a generally comprises a seismic telemetry cable, extending along the seismic streamer 10a and adapted to transmit seismic data towards the vessel.

A seismic streamer 10a generally comprises different kinds of seismic devices (i.e. devices involved in the management of the seismic data) and notably:
seismic sensors 30, such as hydrophones or geophones or accelerometers or the like, arranged along the streamer 10a and adapted for detecting acoustic signals;
electronic units 20, also called nodes, distributed in series along the streamer 10a at intervals that are not necessarily regular, each associated with a given set of seismic sensors 30, the nodes 20 notably processing seismic data issued from sensors 30;
telemetry modules 40, also called concentrators, arranged along the seismic cable 10a, each associated with a given set of nodes 20 notably for providing power supply and retrieving seismic data acquired by the nodes.

The seismic telemetry cable can also be adapted to transmit seismic quality control data (also called “QC data”) towards or from the seismic vessel 11. These data relates to the quality control of the aforementioned seismic devices during their functioning , such as battery level, sensor status, memory status, synchronization availability, etc. For the sake of simplification of description, we shall use the term ‘seismic data’ to refer indifferently to either the payload seismic data or seismic control data.

The seismic streamer 10a also comprises auxiliary equipments (i.e. “non-seismic devices” or “devices not involved in the management of the seismic data”), such as:
an head buoy 12 which typically supports the head end of the streamer 10a connected to the vessel 11;
a tail buoy 13 which typically supports the tail end of the streamer 10a; navigation control devices, commonly referred to as positioning birds (referenced 14 in FIG. 1), which are installed at intervals that are not necessarily regular (50, 150, 300 or 450 meters for example) along the streamer 10a and used to control the depth and lateral position of the streamer 10a;
environmental sensors (non illustrated on figures);
cameras (non illustrated on figures);

etc.

In other words, auxiliary equipment shall be understood throughout this document as any equipment which supplements the aforesaid seismic devices (notably seismic sensors, nodes and telemetry modules) to allow a good operation of the seismic acquisition system.

As shown in FIG. 2, which illustrates in detail the block referenced A in FIG. 1 (i.e. a portion of the streamers 10a), each bird 14 comprises a body 1 equipped with motorized pivoting wings 2 making it possible to modify the position of the streamers laterally between them (this is referred to a horizontal driving) and drive the streamers in immersion (this is referred to a vertical driving). The nodes are represented by hatched squares, referenced 20, in FIGS. 1 and 2.

The nodes 20 are connected to the concentrators 40 via electrical wires (not shown on figures). More precisely, all the nodes are arranged in series along the electrical wires from the head end to the tail end of the streamer 10a. Each node 20 is associated with a given set of seismic sensors 30 and is adapted notably to collect seismic data issued from this set of seismic sensors 30 and to digitize them (if necessary) before sending them, via the concentrators 40 and the seismic telemetry cable, towards the vessel 11. Control data can be also transmitted from the vessel towards the nodes 20, via the concentrators 40 and the seismic telemetry cable, for proper functioning of the seismic acquisition system.

Concentrators 40 are assembled in series along the streamer 10a and each is associated with one or several nodes 20 notably for providing electrical power supply to these nodes 20 and concentrating the seismic data issued from these nodes 20. Then, the concentrators 40 transmit the concentrated data towards the vessel 11, via the seismic telemetry cable in order to be processed in the central unit located onboard the vessel 11. In more details, each concentrator 40 performs different functions and notably:
electrically supplying the nodes 20 and seismic sensors 30 via the telemetry cable;
retrieving seismic data from the nodes and synchronizing data;
locally storing of the seismic data;
routing seismic data, via the telemetry cable, towards the recorder vessel 11;
receiving control data, via the telemetry cable, from the vessel 11 and transmit control data towards the nodes to which the concentrator 40 is associated;
pre-processing seismic data coming from the nodes 20.

As presented in greater detail with reference to FIG. 3, the seismic streamer 10a comprises a seismic telemetry cable 100 extended along the streamer 10a and adapted to transmit seismic data towards the vessel 11.

The seismic telemetry cable 100 comprises at least one data transmission line 110 for transmitting data from seismic devices towards the vessel 11 (e.g. seismic data retrieved from the concentrators 40) and/or from the vessel 11 towards the seismic devices (e.g. control data intended to the concentrators 40 and nodes 20). In other words, the data communication between the aforesaid seismic devices and the vessel 11 via the seismic telemetry cable can be established either unidirectionally or bidirectionally. The data transmission line or lines can be consisted of either one or several electrical cables or one or several optical fibres (e.g. high-speed optical fibers).

The seismic telemetry cable 100 also comprises at least one electrical power supply line 120 for electrically supplying the different seismic devices (20, 30, 40) arranged along the streamer 10a. The electrical supplying lines 120 supply the concentrators 40 with a high voltage (such as a voltage about 300V-400V for example). A power conversion is then performed by a conversion unit comprised within each concentrator 40, each conversion unit allowing to convert the High Voltage received from the electrical power supply line to a Low Voltage to power the nodes 20 and seismic sensors 30 bi-directionally.

The seismic streamer 10a further comprises different auxiliary equipments (for example head buoy 12, tail buoy 13, bird 14, etc.), hereafter referenced as equipment AUX, communicating with the vessel 11 for allowing a good operation of the seismic acquisition system.

The auxiliary equipments are generally designated by different companies and require their own electrical power supply and data transmission lines along the streamer.

Basically, an auxiliary equipment AUX is connected to a connecting module 80, which is entirely dedicated to it. The connecting module 80 enables said equipment AUX to communicate auxiliary data with the vessel 11, via a dedicated auxiliary cable 50 comprised within the streamer 10a, which is different from the seismic telemetry cable 100. The dedicated auxiliary cable 50 comprises an auxiliary data transmission line 60 and an auxiliary electrical power supply line 70. The connecting module 80 is connected to auxiliary data transmission line 60 to communicate auxiliary data with the vessel 11 and connected to the auxiliary electrical power supply line 70 to electrically supply said equipment AUX to which the connecting module 80 is associated.

In other words, the connecting module 80 is configured to operate interface:
between the equipment AUX and the auxiliary data transmission line 60, by transmitting data acquired by the equipment AUX through the dedicated auxiliary line 60 towards the vessel 11 and/or by transmitting data from the vessel 11 towards the equipment AUX, and
between the equipment AUX and the auxiliary electrical power supply line 70 for electrically supplying the AUX equipment.

However, the use of conventional connecting modules connected to the equipment AUX requires the integration of additional electrical lines within the seismic streamers, which has a significant impact on the overall weight and size of the streamers, and therefore on the production cost of the seismic acquisition system.

In addition, the presence of different types of connecting modules makes the management of auxiliary equipments in the seismic acquisition system complex. Especially, the higher is the number of connecting modules of different types, the more difficult the troubleshooting operations become.

### 4. SUMMARY

A particular aspect of the present disclosure relates to a seismic data acquisition system comprising at least one marine seismic streamer towed by a vessel, said at least one seismic streamer comprising a seismic telemetry cable, extending along said at least one seismic streamer and adapted to communicate seismic data with the vessel, and at least one connecting module to which is connected an auxiliary equipment. Said at least one connecting module is such that it is connected to said seismic telemetry cable, enabling said auxiliary equipment to communicate auxiliary data with said vessel, via said connecting module and said seismic telemetry cable.

Thus, an exemplary aspect of the present disclosure taking advantage of the seismic telemetry cable present within the streamer, to further manage the communication of auxiliary data. Thus, thanks to the connecting module, the seismic acquisition system does not require any usual dedicated auxiliary cable to communicate with the vessel. This enables to reduce the seismic streamer size and weight and therefore offers a cost-effective seismic streamer, contrary to the prior art solutions. This is all the more surprising in that, for the person skilled, using a same seismic telemetry cable for conveying both seismic data and auxiliary data, should have increased the risk of pollution of seismic data by the auxiliary data.

The term ‘communicate seismic data’ means that the seismic data are either transmitted toward the vessel or transmitted from the vessel. The seismic data belongs to the group comprising: payload seismic data transmitted towards the vessel and seismic control data transmitted from the vessel or towards the vessel.

The term ‘communicate auxiliary data’ means that the auxiliary data are either transmitted from the auxiliary equipment toward the vessel or transmitted from the vessel toward the auxiliary equipment.

According to a particular feature, said auxiliary data comprise first auxiliary data transmitted from said vessel and second auxiliary data transmitted towards said vessel.

Thus, the communication of auxiliary data between the auxiliary equipment and the vessel can be carried out bidirectionally via the seismic telemetry cable.

According to a particular feature, said at least one connecting module is connected to at least one data transmission line and/or at least one electrical power supply line comprised in said seismic telemetry cable.

Thus, it is possible to take advantage of the electrical power supply line already comprised in the seismic telemetry cable to also manage the electrical supplying of the auxiliary equipment. This avoids the need of a dedicated electrical power supply line. The high voltage supplying the seismic devices along the telemetry cable is sufficient to also supply the connecting module and the auxiliary equipment to which it is connected thanks to a mechanism of conversion of electrical power implemented at each concentrator along the streamers.

According to a particular feature, the system comprises at least one seismic device including a first interface circuit connected to said at least one data transmission line, enabling said at least one seismic device to communicate seismic data with said vessel, via said at least one data transmission line. Said at least one connecting module includes a second interface circuit identical to said first interface circuit.

In that way, the connecting module connected to the auxiliary equipment behaves as a seismic device and therefore operates interface with the data transmission line as if it were a seismic device from the point of view of the seismic acquisition system.

According to a particular feature, said at least one seismic device belongs to the group comprising:
seismic sensors;
electronic units;
telemetry modules.

According to a particular feature, said auxiliary equipment belongs to the group comprising:
head buoys which support an head end of said at least one seismic streamer;
tail buoys which support a tail end of said at least one seismic streamer;
navigation control devices adapted to control depth and lateral position of the seismic streamer;
environmental sensors;
passive acoustic monitoring (PAM) devices; and
cameras.

Navigation control devices can be any streamer positioning devices that aims to modify the position of the streamers, such as compas, positioning birds or pings.

According to a particular feature, the vessel comprises means for receiving said seismic data and said second auxiliary data via said telemetry cable, and means for dispatching said seismic data towards a first data management unit, and said second auxiliary data towards a second data management unit, different from said first data management unit.

Another aspect of the present disclosure relates to a connecting module intended to be connected to an auxiliary equipment and comprised in at least one marine seismic streamer of a seismic data acquisition system, said at least one seismic streamer being towed by a vessel and comprising a seismic telemetry cable extending along said at least one seismic streamer and adapted to transmit seismic data towards the vessel. Said connecting module is such that it comprises means for connecting to said seismic telemetry cable, enabling said auxiliary equipment to communicate auxiliary data with said vessel, via said connecting module and said seismic telemetry cable.

Another aspect of the present disclosure relates to a data management system comprised onboard of a vessel towing at least one marine seismic streamer of a seismic data acquisition system, said at least one seismic streamer comprising a seismic telemetry cable, extending along said at least one seismic streamer and adapted to communicate seismic data with the vessel, and at least one connecting module to which is connected an auxiliary equipment, said at least one connecting module being connected to said seismic telemetry cable, enabling said auxiliary equipment to transmit auxiliary data towards said vessel, via said connecting module and said seismic telemetry cable. Said data management system is such that it comprises:
means for receiving said seismic data and said auxiliary data via said telemetry cable, and
means for dispatching said seismic data towards a first data management unit, and said auxiliary data towards a second data management unit, different from said first data management unit.

### 5. LIST OF FIGURES

Other features and advantages of embodiments shall appear from the following description, given by way of an indicative and non-exhaustive examples and from the appended drawings, of which:

FIG. 1, already described with reference to the prior art, presents an example of network of seismic streamers towed by a seismic vessel;

FIG. 2, already described with reference to the prior art, illustrates in detail the classic structure of a portion of seismic streamer of FIG. 1;

FIG. 3, already described with reference to the prior art, illustrates in detail is the classic structure of a portion of seismic streamer of FIG. 1 comprising a connecting module to which is connected an auxiliary equipment;

FIG. 4 illustrates the structure of a portion of seismic streamer of a seismic data acquisition system, on the auxiliary equipment side, according to a particular embodiment;

FIG. 5 illustrates the structure of a seismic data acquisition system, on the vessel side, according to a particular embodiment.

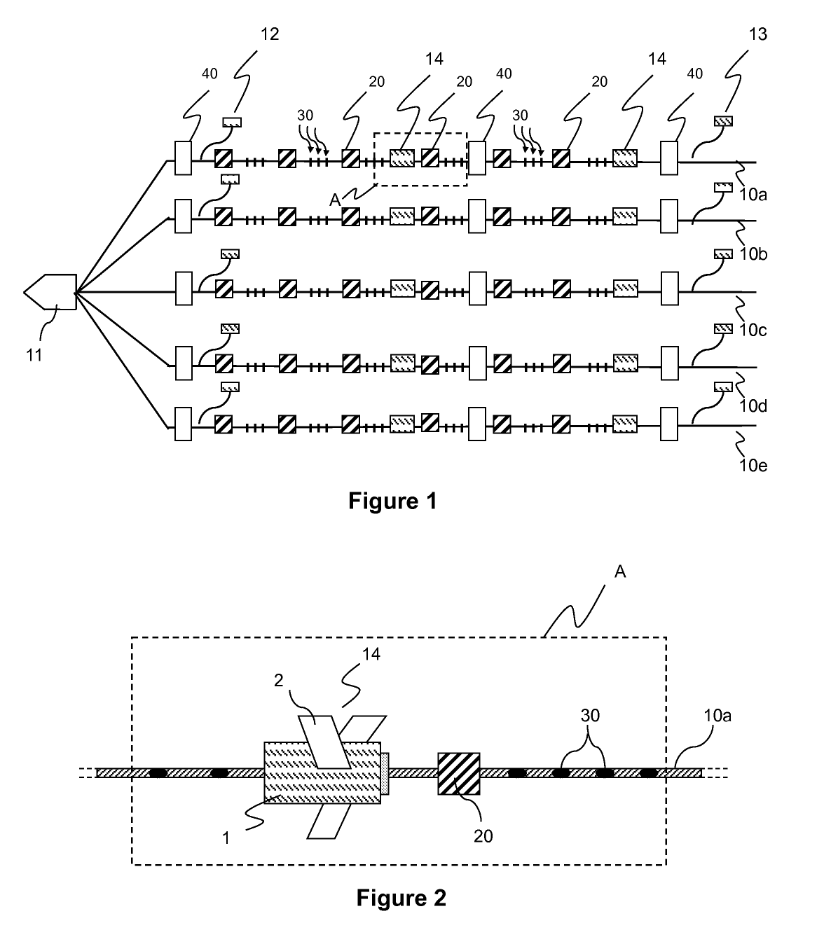

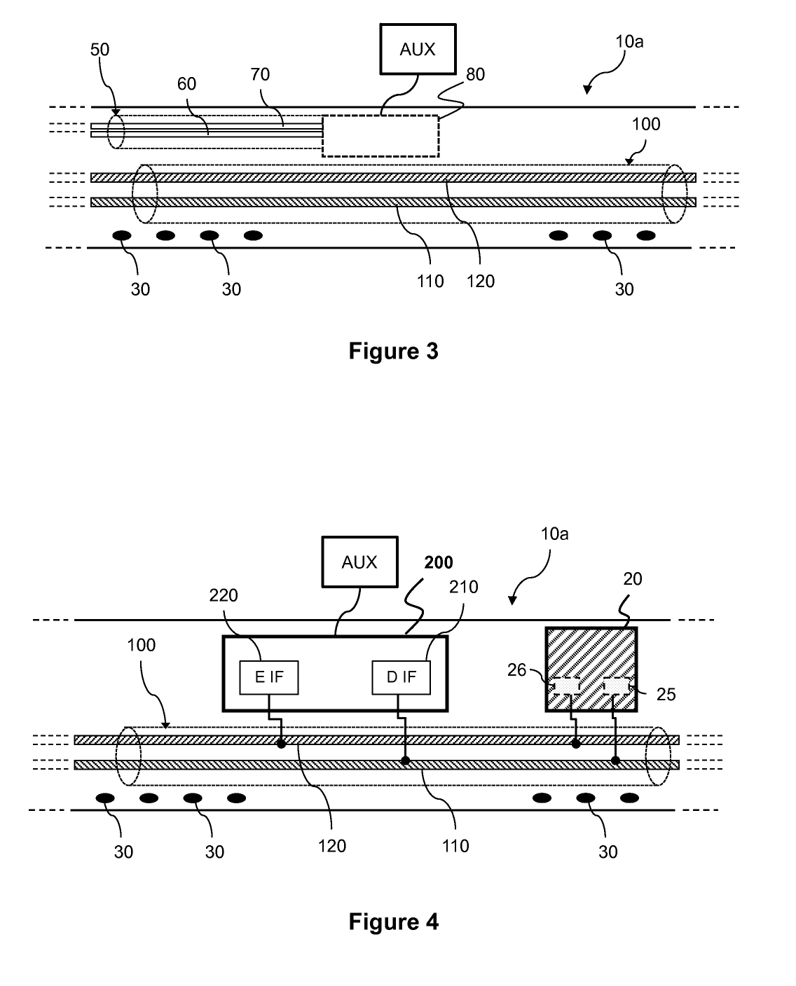

### 6. DETAILED DESCRIPTION

In all of the figures of the present document, identical elements are designated by the same numerical reference sign.

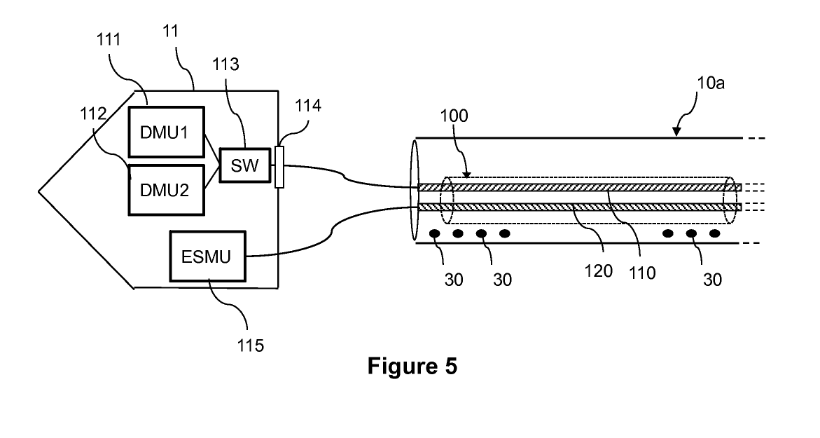

Referring now to FIGS. 4 and 5, we recall some essential characteristics of the seismic data acquisition system according a particular embodiment of the disclosure.

We present first, in relation with FIG. 4, the functioning of the seismic data acquisition system on the auxiliary module side, according to a particular embodiment of the disclosure.

The seismic streamer 10a comprises a connecting module 200 to which is connected the equipment AUX. The connecting module 200 is connected, via a suitable connection, to the seismic telemetry cable 100 so that the equipment AUX, to which is connected, can communicate auxiliary data with the vessel 11, via the connecting module 200 and the seismic telemetry cable 100.

The portion of seismic streamer 10a illustrated here also comprises a seismic device, of the type node 20, which has a first interface circuit (or interface block) 25 connected to the data transmission line 110 of the seismic telemetry cable 100. This first interface circuit 25 is configured to enable the node 20 to communicate seismic data with the vessel 11, via the data transmission line 110 according to a data transfer protocol implemented by the seismic acquisition system. The communication of seismic data with the vessel 11 can be established from the node 20 towards the vessel 11 and from the vessel 11 towards the node 20. Seismic data can be payload seismic data or seismic control data.

The node 20 also has a second interface circuit (or interface block) 26 connected to the electrical power supply line 120 of the seismic telemetry cable 100. This second interface circuit 26 is configured to enable the node 20 to be supplied in electrical energy via the electrical power supply line 120, for example, from the vessel 11.

As the node 20 (or, more generally, as any type of seismic device), the connecting module 200 comprises a first interface circuit 210 (referenced “D IF” for Data Interface) connected to the data transmission line 110 of the seismic telemetry cable 100 and a second interface circuit 220 (referenced “E IF” Electrical Interface) connected to the electrical power supply line 120 of the seismic telemetry cable 100. The interface circuit 210 is configured to enable the equipment AUX to communicate auxiliary data with the vessel 11, via the connecting module 200 and the data transmission line 110, according to the data transfer protocol implemented by the seismic acquisition system. The auxiliary data with the vessel 11 can be transmitted from the equipment AUX towards the vessel 11 and from the vessel 11 towards the equipment AUX (bidirectional communication). The second interface circuit 220 is configured to enable the node 20 to be supplied in electrical energy via the electrical power supply line 120, for example, from the vessel 11.

Thanks to these first and second interface circuit 210, 220 comprised in the connecting module, the equipment AUX connected to the connected module 200 behaves as a node, making possible the equipment AUX to operate interface, via the connecting module 200, respectively with the data transmission and electrical power supply lines 110, 120 comprised in the seismic telemetry cable 100, as if it were a node of the seismic acquisition system.

Thus, in taking advantage of the seismic telemetry cable 100 present within the streamer 10a, to further manage the communication of auxiliary data and the supply of electrical energy, via the connecting module 200, the seismic acquisition system does not require any usual dedicated auxiliary cable to perform these functions. This therefore enables to reduce the seismic streamer size and weight and therefore offers a cost-effective seismic streamer. This is all the more surprising in that, for the person skilled, using a same seismic telemetry cable for conveying both seismic data and auxiliary data, should have increased the risk of pollution of seismic data by the auxiliary data.

The equipment AUX belongs to the group comprising:
head buoys which support an head end of said at least one seismic streamer;
tail buoys which support a tail end of said at least one seismic streamer;
navigation control devices (or any positioning devices like compass, positioning birds or pings) adapted to control depth and lateral position of the seismic streamer;
environmental sensors
passive acoustic monitoring (PAM) devices; and
cameras.

Whatever the type of equipment AUX used in the seismic acquisition system, the connecting module 200 to which is connected remain identical in its main functioning (auxiliary data communication and electrical power supply management), as it can be considered as a seismic device from the system's point of view.

The streamer 10a shown in FIG. 4 contains only one auxiliary equipment connected to a connecting module. The number of auxiliary equipments represented is deliberately limited purely for the purposes of pedagogical description, and so as not to burden the figure and the associated description. Of course, in order to obtain ensure a good operation of the seismic acquisition system, a greater number of auxiliary equipments and of connecting module associated is necessary.

We present now, in relation with FIG. 5, the functioning of the seismic data acquisition system on the vessel side, according to a particular embodiment of the disclosure.

The vessel 11 implements onboard a data management system comprising a receiving unit 114, a dispatching unit 113 (referenced as “SW” in FIG. 5), a first data management unit 111 (referenced as “DMU1” in FIG. 5) and a second data management unit 112 (referenced as “DMU2” in FIG. 5).

The receiving unit 114 is connected to the data transmission line 110 and adapted for receiving:
the seismic data from the seismic devices (and especially from the concentrators 40 which retrieve the seismic data coming from nodes) comprised in the streamer 10a, via the transmission line 110 of telemetry cable 100, and
the auxiliary data from the equipments AUX, via the connecting modules 200 and the transmission line 110 of telemetry cable 100.

The dispatching unit 113 is adapted for dispatching the seismic data received by the receiving unit 114, towards the first data management unit 111, where the seismic data are stored and processed, and the auxiliary data received by the receiving unit 114, towards the second data management unit 112, where the auxiliary data are stored and processed. The dispatching unit 113 comprises a circuit configured to detect the auxiliary data from the seismic data in the data stream conveyed by the telemetry cable 100.

It should be noted that the data management system here above described carried out a data management according to an “uplink” direction, i.e. from the telemetry cable 100 of the streamer 10a towards the vessel 11. Of course, this data management system can be configured to manage the data communication in the “downlink” direction, i.e. from the vessel 11 towards the telemetry cable 100. In that case, the data management units 111 and 112 transmit each their own data to the dispatching unit 113, which is then configured to concentrate the data and transmit them over the telemetry cable 100, according to the data transfer protocol implemented by the seismic acquisition system, via a emitting unit (not shown on the figure). The dispatching unit 113 is adapted notably to encapsulate the auxiliary data and seismic data (if any) in accordance with the data transfer protocol, before transmitting them through the telemetry cable 100.

The vessel also comprises onboard an electrical power supply management unit 115 which provides electrical power both to the seismic devices (concentrators 40, nodes 20, sensors 30) and the auxiliary equipments via their connecting modules. The supply management unit 115 supplies in series the seismic devices and auxiliary equipments via their connecting module with a high voltage (such as a voltage about 300V-400V for example), but a conversion unit comprised within each concentrator 40 converts the High Voltage received from the electrical power supply line 120 to a Low Voltage to power the nodes 20, seismic sensors 30 and auxiliary equipments with an adequate amount of voltage. The high voltage supplying the seismic devices along the telemetry cable is sufficient to also supply the connecting module and the auxiliary equipment to which it is connected thanks to a mechanism of conversion of electrical power implemented at each concentrator along the streamers.

In an exemplary embodiment, the receiving unit 114, dispatching unit 113, first data management unit 111 and second data management unit 112 include electronic circuitry configured to perform their respective functions. For example, each unit may be implemented in hardware only or a combination of hardware and software. In one embodiment, one or more of the units, such as the data management units, are implemented at least in part by a processor and a non-transitory computer-readable medium storing instructions, which when executed by the processor configure the processor to perform one or more of the functions of the data management unit.

An exemplary embodiment of the disclosure provides a seismic data acquisition system implementing a network of seismic streamers of lightered and reduced size structure.

An exemplary embodiment of the disclosure provides a seismic data acquisition system implementing a network of cost-effective seismic streamers.

An exemplary embodiment of the disclosure provides a technique that allows a simplified management of auxiliary equipments in a seismic data acquisition system.

An exemplary embodiment of the disclosure provides a technique that reduces the risk of troubleshooting.

Although the present disclosure has been described with reference to one or more examples, workers skilled in the art will recognize that changes may be made in form and detail without departing from the scope of the disclosure and/or the appended claims.

What is claimed is:

1. A seismic data acquisition system comprising:
at least one marine seismic streamer towed by a vessel, said at least one seismic streamer comprising:
a seismic telemetry cable, extending along said at least one seismic streamer and configured to communicate seismic data with the vessel; and
at least one connecting module to which is connected an auxiliary equipment, wherein said at least one connecting module is connected to said seismic telemetry cable, enabling said auxiliary equipment to communicate auxiliary data with said vessel, via said connecting module and said seismic telemetry cable.

2. The system according to claim 1, wherein said auxiliary data comprise first auxiliary data transmitted from said vessel and second auxiliary data transmitted towards said vessel.

3. The system according to claim 1, wherein said at least one connecting module is connected to at least one data transmission line and/or at least one electrical power supply line comprised in said seismic telemetry cable.

4. The system according to claim 3, comprising at least one seismic device including a first interface circuit connected to said at least one data transmission line, enabling said at least one seismic device to communicate seismic data with said vessel, via said at least one data transmission line, and wherein said at least one connecting module including a second interface circuit identical to said first interface circuit.

5. The system according to claim 4, wherein said at least one seismic device belongs to the group comprising:
seismic sensors;
electronic units;
telemetry modules.

6. The system according to claim 1, wherein said auxiliary equipment belongs to the group consisting of:
head buoys which support an head end of said at least one seismic streamer;
tail buoys which support a tail end of said at least one seismic streamer;
navigation control devices adapted to control depth and lateral position of the seismic streamer;
environmental sensors;
passive acoustic monitoring devices; and
cameras.

7. The system according to claim 2, wherein the vessel comprises means for receiving said seismic data and said second auxiliary data via said telemetry cable, and means for dispatching said seismic data towards a first data management unit, and said second auxiliary data towards a second data management unit, different from said first data management unit.

8. A connecting module configured to be connected to an auxiliary equipment and comprised in at least one marine seismic streamer of a seismic data acquisition system, said at least one seismic streamer being towed by a vessel and comprising a seismic telemetry cable extending along said at least one seismic streamer and adapted to transmit seismic data towards the vessel, wherein said connecting module comprises:
an interface circuit configured to connect to said seismic telemetry cable and enable said auxiliary equipment to communicate auxiliary data with said vessel, via said connecting module and said seismic telemetry cable.

9. A data management system comprised onboard of a vessel towing at least one marine seismic streamer of a seismic data acquisition system, said at least one seismic streamer comprising a seismic telemetry cable, extending along said at least one seismic streamer and adapted to communicate seismic data with the vessel, and at least one connecting module to which is connected an auxiliary equipment, said at least one connecting module being connected to said seismic telemetry cable, enabling said auxiliary equipment to transmit auxiliary data towards said vessel, via said connecting module and said seismic telemetry cable, wherein said data management system comprises:
a receiving unit configured to receive said seismic data and said auxiliary data via said telemetry cable, and
a dispatching unit configured to dispatch said seismic data towards a first data management unit, and said auxiliary data towards a second data management unit, different from said first data management unit.
